(19) United States
(12) Patent Application Publication
(10) Pub. No.: US 2010/0085474 A1
(43) Pub. Date: Apr. 8, 2010

(54) CAMERA MODULE

(75) Inventor: Masaya MORITA, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/569,686

(22) Filed: Sep. 29, 2009

(30) Foreign Application Priority Data
Oct. 3, 2008 (JP) 2008-258134

(51) Int. Cl. H04N 5/225

(52) U.S. Cl. 348/374; 348/E05.024

(57) ABSTRACT

A camera module has a sensor unit holding an image sensor and a lens unit holding a taking lens. The sensor unit and the lens unit are joined in such a manner that an imaging plane of the image sensor is orthogonal to an optical axis of the taking lens. Each of top and bottom surfaces of the lens unit has a pair of held members to be held by holding jigs. This held member is a depression of triangular cross section defined by a bottom face that inclines toward rear surface of the lens unit. Each held member contains a positioning member that receives a pin jig when the position and angle of the sensor unit is adjusted relative to the lens unit.

### FIELD OF THE INVENTION

The present invention relates to a camera module made up of a sensor unit holding an image sensor and a lens unit holding a taking lens.

### BACKGROUND OF THE INVENTION

A camera module is an integration of a lens unit holding a taking lens and a sensor unit holding an image sensor, such as a CCD or CMOS. A typical camera module is small enough to fit in the casings of mobile phones and door phones.

Earlier camera modules are generally equipped with low-resolution image sensors of no more than 1-2 million pixels. Having a large aperture ratio, this type of low-resolution image sensor does not require precise positioning between the taking lens and the image sensor to produce an image with resolution equivalent to the number of pixels.

Current camera modules, in contrast, employ a larger number of pixels, as with normal digital cameras, and even have high-resolution image sensors of up to 3-5 million pixels. The high-resolution image sensors have a small aperture ratio, and require precise positioning between the taking lens and the image sensor to produce an image with resolution equivalent to the number of pixels.

In a typical assembling process of the camera module, the lens unit is held by two holding mechanisms, and moved to adjust its relative position to the sensor unit that is kept immobilized. In this condition, a test chart is captured with the image sensor through the lens unit. The posture (or position) of the lens unit is then changed until the captured image comes with a predetermined resolution, and the lens unit is joined to the sensor unit with a UV curable resin (see, Japanese Patent Laid-open Publication No. 2005-198103).

To adjust the relative positions of the lens unit and the sensor unit, a positioning member must be provided as a reference plane on at least one of these units. The camera module is generally a small cube, about 10 millimeters on a side. Because of space limitation, accordingly, the positioning member is often provided on a front or rear surface of the unit. Additionally, the camera module needs to have a held member to be held by a jig in quality inspection after assembly.

By the way, there is a standard called SMIA (Standard Mobile Imaging Architecture) for the camera modules. The SMIA defines the interface between the camera module and an electronic device incorporating the camera module. A typical SMIA camera module has a terminal group on its rear surface (or namely, the rear surface of the sensor unit) for sending and receiving signals from the electronic device. Additionally, the camera modules have image capturing windows on their front surfaces (or namely, the front surface of the lens unit) for introducing the light from a photographic subject.

Recently, there is a need for more compact camera modules. If the camera module is further downsized, however, the image capturing window and the terminal group will occupy a large part of the module. It is therefore difficult to provide the positioning member on the front or rear surface of at least one of the lens unit and the sensor unit.

### SUMMARY OF THE INVENTION

In view of the foregoing, it is an object of the present invention to provide a camera module capable of maintaining a space for a positioning member despite the space limitation due to downsizing.

In order to achieve the above and other objects, the camera module according to the present invention has a lens unit holding a taking lens and a sensor unit holding an image sensor, and includes held members and positioning members. The held members are provided in pairs on top and bottom surfaces or both lateral surfaces of one of the lens unit and the sensor unit. These held members are held by a holding jig as the camera module is inspected. The positioning members are provided in the held members, and used for adjusting relative positions and angles of the lens unit and the sensor unit.

In a preferred embodiment of the present invention, the lens unit is a quadrilateral box. The held member is a depression of triangular cross section, and includes a bottom face inclined toward the image sensor.

The positioning member is a positioning hole extending orthogonal to an optical axis of the taking lens. This positioning hole receives a pin jig for holding the lens unit as the lens unit and the sensor unit are joined together.

In another preferred embodiment of the present invention, the positioning member includes a positioning surface and a positioning hole. The positioning surface is formed within the bottom face of the held member, and extends parallel to an optical axis of the taking lens. The positioning hole is formed on the positioning surface, and extends orthogonal to the optical axis. This positioning hole receives a pin jig that has a shoulder portion to make contact with the positioning surface, and holds the lens unit as the lens unit and the sensor unit are joined together.

According to the present invention, the positioning members are provided in the held members formed on the top and bottom or both lateral surfaces of the camera module. It is therefore possible to maintain the spaces for the positioning members despite the space limitation due to downsizing of the camera module.

### BRIEF DESCRIPTION OF THE DRAWINGS

The above objects and advantages of the present invention will become more apparent from the following detailed description when read in connection with the accompanying drawings, in which:

FIG. 1 is an exterior perspective view of a camera module according to the present invention;

FIG. 2 is an exploded perspective view of the camera module;

FIG. 3 is a horizontal cross-sectional view of the camera module;

FIG. 4 is a rear perspective view of a sensor unit;

FIG. 5 is an exploded perspective view of a lens unit;

FIG. 6 is a cross-sectional view of the camera module as taken along an optical axis at a position of a held member;

FIG. 7 is a side view showing the held member and a locking claw of a module holding device;

FIG. 8 is a schematic side view of an assembly machine;

FIG. 9 is a partial perspective view of a lens holding device of the assembly machine;

FIG. 10 is a cross-sectional view of the lens unit on the lens holding device, as taken along the optical axis;

FIG. 11 is a partial perspective view of a sensor holding device of the assembly machine;

FIG. 12 is a cross-sectional view of the lens unit and the sensor unit in an adhesion process, as taken along the optical axis;

FIG. 13 is a perspective view of the module holding device in a quality inspection process;

FIG. 14 is a cross-sectional view of the camera module on the module holding device, as taken along the optical axis; and

FIG. 15 is a cross-sectional view of a held member according to another embodiment.

### DETAILED DESCRIPTION OF THE PREFERRED EMBODIMENTS

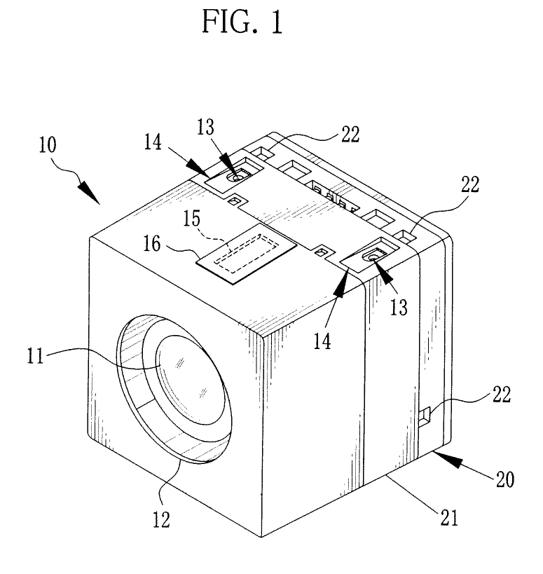

Referring to FIG. 1, a camera module 10 has a cubic shape of about 6-10 mm cube, designed for installation in mobile camera phones and such electronic devices. The camera module 10 has an image capturing window 12 on the front surface for exposing a taking lens 11, and pairs of held members (receiving portions) 14 each having a positioning member 13 on the top and bottom surfaces. Also on the top surface is formed an opening 15 for inserting a probe of an assembly machine, and this opening 15 is covered by a plate 16 after assembly.

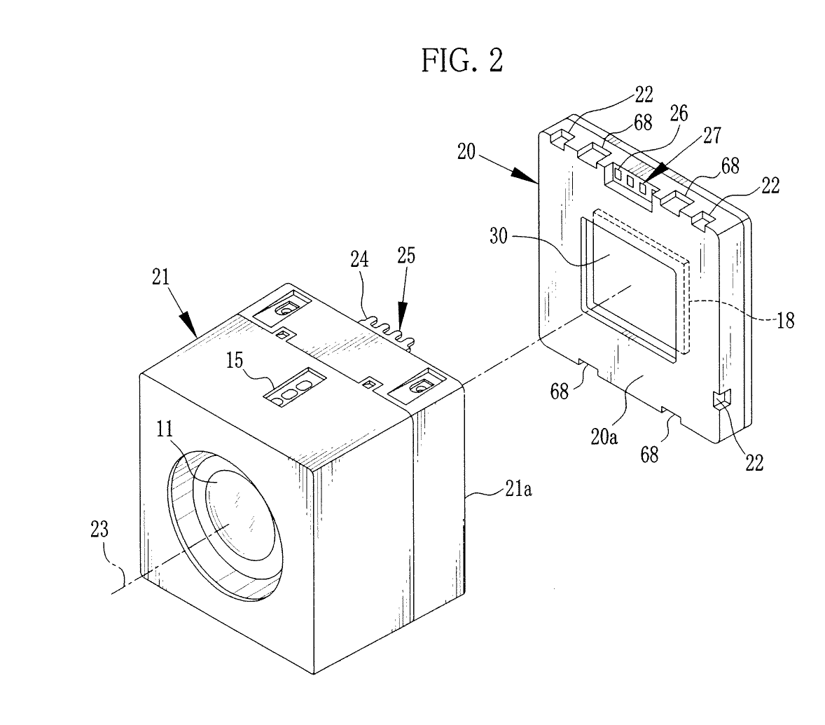

As shown in FIG. 2, the camera module 10 includes a sensor unit 20 and a lens unit 21. The sensor unit 20 is positioned in such a manner that its imaging plane is orthogonal to an imaging optical axis 23 (the optical axis of the taking lens 11), and then fixed to the lens unit 21. More specifically, two mating surfaces 20a, 21a of the sensor unit 20 and the lens unit 21 are joined by firstly applying an ultraviolet (UV) curable adhesive resin into adhesive receivers (receiving ports) 22 on the side surfaces of the sensor unit 20, and then irradiating UV rays to cure the adhesive resin.

Each adhesive receiver 22 is a concavity that partially opens on the mating surface 20a of the sensor unit 20. The adhesive receivers 22 are located on either ends of the top surface across the imaging optical axis 23, and also on the right lateral surface.

On the mating surface 21a of the lens unit 21, a terminal group 25 of a flexible board 24 thrusts outward. On the mating surface 20a of the sensor unit 20, there is formed a cutout 26 with a contact group 27. When the lens unit 21 and the sensor unit 20 are joined, the terminal group 25 is electrically connected to the contact group 27 by a conductive adhesive or the like.

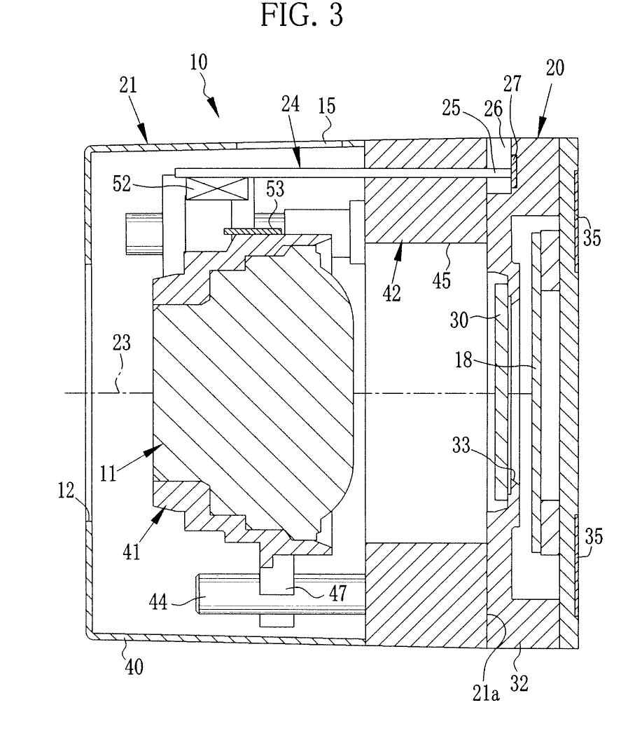

As shown in FIG. 3, the sensor unit 20 has an IR cut filter 30 and an image sensor 18 in a housing 32. The IR cut filter 30 covers an exposure aperture 33 on the housing 32. The image sensor 18 is located behind the IR cut filter 30.

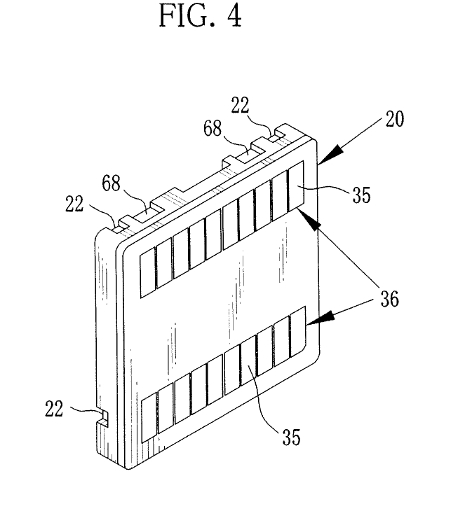

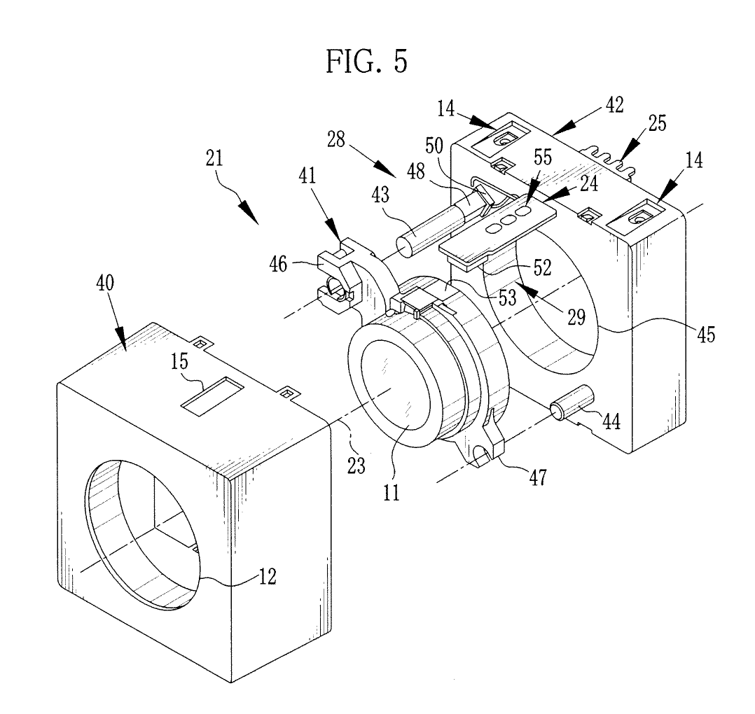

As shown in FIG. 4, on the rear surface of the sensor unit 20 is exposed a rear terminal group 36 made up of a plurality of regularly arranged terminals 35, which are connectable to contact points of the mobile phones or such devices. A part of the rear terminal group 36 is electrically connected to the image sensor 18 by a conductive element (not shown). The rest of the rear terminal group 36 is connected to a lens drive system 28 and a lens position detector 29 (both in FIG. 5) of the lens unit 21 through the flexible board 24.

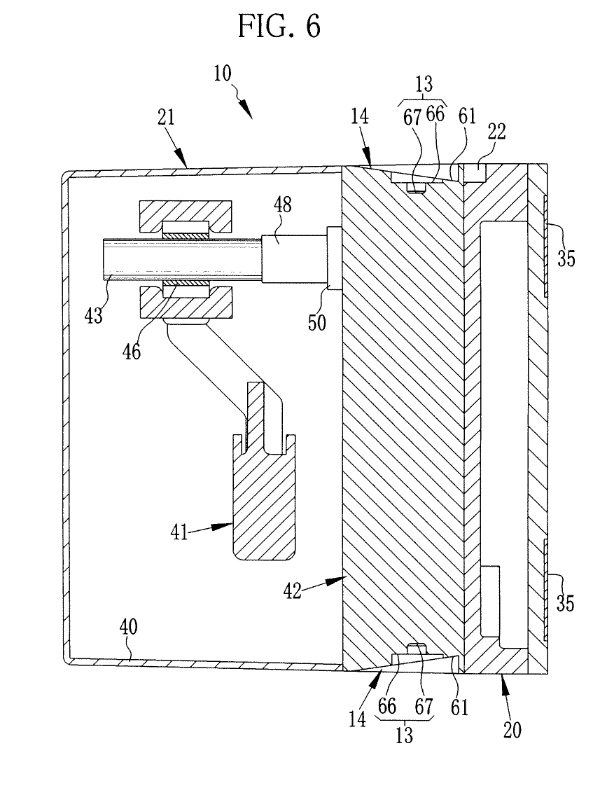

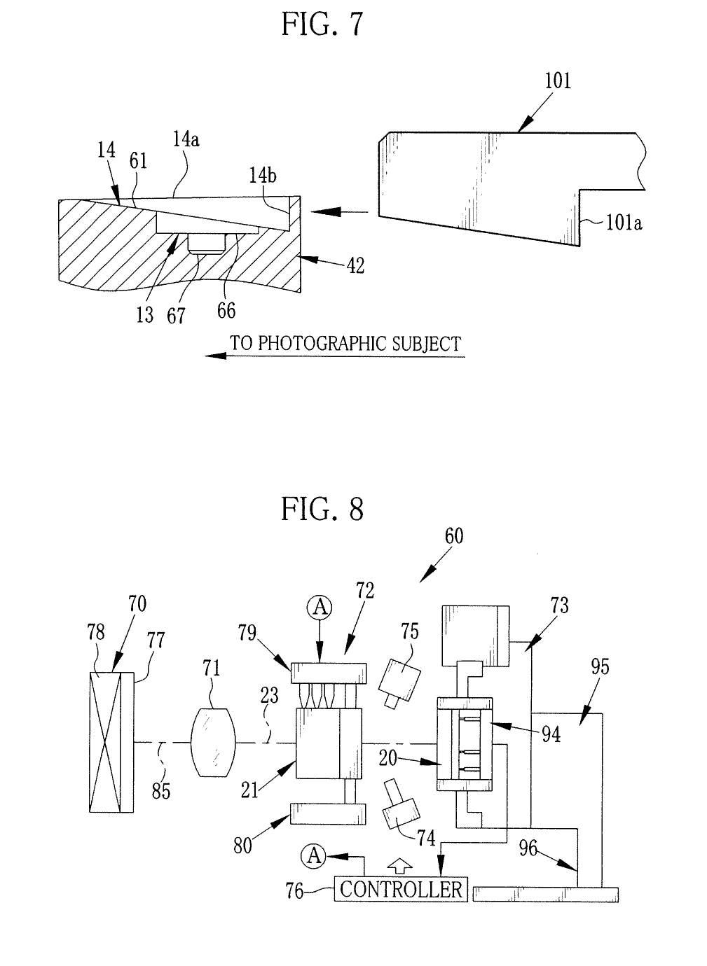

As shown in FIG. 5 and FIG. 6, the lens unit 21 includes a lens cover 40, a lens holder 41 and a support block 42. The lens cover 40 encloses a subject light path extending between the image capturing window 12 and the exposure aperture 33. This lens cover 40 has a plurality of elastic locking claws (not shown) to catch the support block 42 in a detachable manner.

The lens holder 41 holds the taking lens 11, and is housed within the lens cover 40. The support block 42 has an opening 45 for passing the subject light. The support block 42 also has a rod 43, a guide shaft 44 and the flexible board 24. Additionally, a pair of held members 14 are provided on each of the top and bottom surfaces. These held members 14 are seized by a module holding device in a quality inspection process.

The lens holder 41 has first and second bearing arms 46, 47. The first bearing arm 46 fits onto the rod 43 with a certain frictional force. The rod 43 extends parallel to the imaging optical axis 23. The second bearing arm 47 fits onto the guide shaft 44 extending parallel to the rod 43, and blocks rotation of the lens holder 41.

The lens drive system 28 is composed of the rod 43, a piezo element 48 and a support base 50. The piezo element 48, which is a stack of piezoelectric plates, is attached on one end in its stretching direction to the support base 50, and on the other end to the rod 43. Upon application of saw-tooth pulses from an external device, the piezo element 48 stretches and shrinks to vibrate the rod 43 in the axial direction. This vibration moves the lens holder 41 along the imaging optical axis 23 for focusing. The support base 50 is attached to the front surface of the support block 42.

The lens position detector 29 is composed of a Hall element 52 on the tip of the flexible board 24 and an Nd (neodymium) magnet 53 arranged on the lens holder 41 to face the Hall element 52. The Hall element 52 is placed above a pathway of the lens holder 41. This Hall element 52 detects the change in magnetoresistance, and finds the location of the Nd magnet 53, or namely the lens holder 41. Based on this location information, the position of the taking lens 11 is controlled during the focusing operation.

On the flexible board 24, there is provided a contact group 55 made up of a plurality of contact points. This contact group 55 is exposed from the opening 15 as the lens cover 40 is attached to the support block 42. The contact group 55 is connected to probes in a later-described position adjustment process. These probes send drive signals for moving the taking lens 11, and also receive lens location detection signals from the camera module 10 by way of the contact group 55.

The lens unit 21 has the positioning member 13 in each of the held members 14. The positioning member is composed of a positioning surface 66 and a positioning hole 67. The positioning surface 66 is parallel to the imaging optical axis 23. The positioning hole 67 is formed to a certain depth within the positioning surface 66, and orthogonal to the imaging optical axis 23. These positioning surface 66 and positioning hole 67 operate as reference planes in the position adjustment process to precisely adjust both the position and the angle of the lens unit 21 relative to the sensor unit 20. In this regard, exterior surfaces 14a (including the top and bottom surfaces) are all inclined so as to facilitate demolding. Accordingly, the exterior surfaces 14a cannot be used as reference planes.

A pair of cutouts 68 (see, FIG. 2) are provided on each of the top and bottom surfaces of the sensor unit 20. The sensor unit 20 is held by use of these cutouts 68 during the position adjustment process.

The position adjustment process is followed by a fixing process. The fixing process starts by applying the UV curable adhesive resin in the adhesive receivers 22. UV rays are then irradiated to fix the sensor unit 20 and the lens unit 21 together. Thereafter, the terminal group 25 of the flexible board 24 is connected to the contact group 27 of the sensor unit 20, and lastly the opening 15 is closed with the plate 16. This assembled camera module 10 is sent to a line of quality inspection process.

In the quality inspection process, the camera module 10 is held in a certain position and driven with the electric power and the signals externally provided through the rear terminal group 36, and then inspected for its operation and image quality.

This quality inspection process is conducted using a module holding device 100 (see, FIG. 13) for holding the camera module 10. The module holding device 100 has a plurality of elastic locking claws (holding jigs) 101 to engage with the held members 14 of the camera module 10. The held members 14 are depressions of triangular cross section that corresponds to the shape of the locking claws 101. The held member 14 is composed of a bottom face 61 that inclines toward an imaging plane and an engaged face 14b that stands upright from the lower end of the bottom face 61. The engaged face 14b comes into contact with an engaging face 101a of the locking claw 101 as the locking claw 101 fits into the held member 14. In this regard, the engaged face 14b may incline slightly toward a photographic subject or the imaging plane, and still has effect.

Next, the procedure of assembling the camera module 10 is described. The sensor unit 20 and the lens unit 21 are built separately, and sent to a position adjustment line. In the position adjustment process, the sensor unit 20 and the lens unit 21 are set in an assembly machine 60. As shown in FIG. 8, the assembly machine 60 includes a chart unit 70, a condenser lens 71, a lens holding device 72 for holding the lens unit 21, a sensor holding device 73 for holding the sensor unit 20, a resin injector 74, an UV ray irradiator 75 and a controller 76 for controlling these components.

The chart unit 70 is composed of a test chart 77 and alight source 78 for emitting parallel light to illuminate the test chart 77 from behind. The test chart 77 is made of, for example, a plastic light diffuser panel. The condenser lens 71 collects the light from the chart unit 70, and guides it to the lens unit 21.

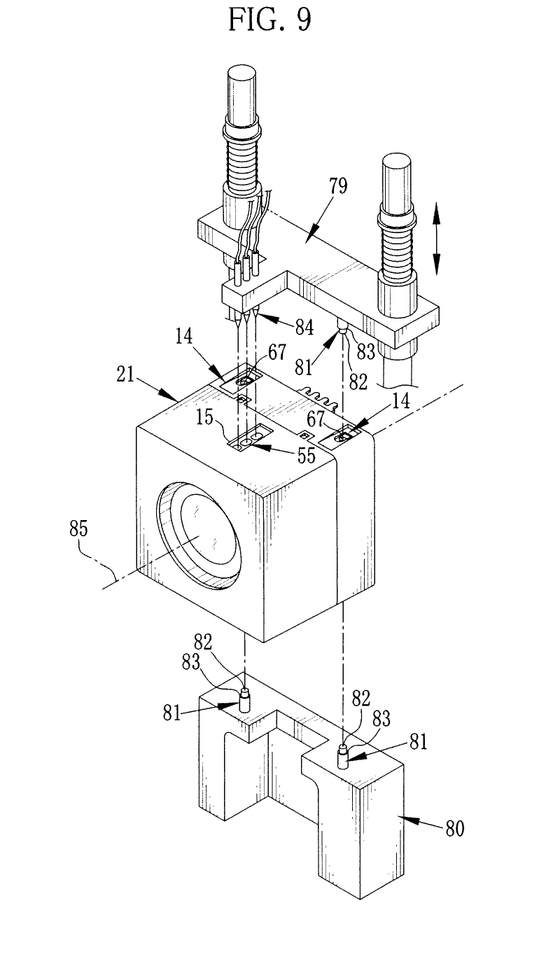

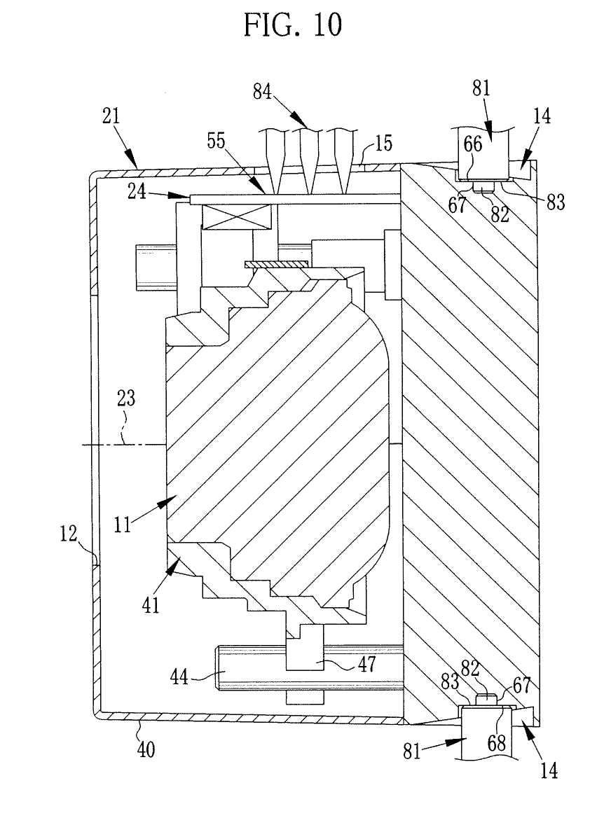

As shown in FIG. 9 and FIG. 10, the lens holding device 72 has an upper support plate 79 and a lower support plate 80 both equipped with a plurality of positioning rods 81. The lower support plate 80 is stationary, and its positioning rods 81 stand upright on the upper surface. Each of the positioning rods 81 has a small-diameter positioning pin (pin jig) 82 on the tip. This positioning pin 82 enters the positioning hole 67 on the bottom surface of the lens unit 21. At this point, a shoulder portion 83 of the positioning rod 81 comes into contact with the positioning surface 66.

The upper support plate 79 is movable in the vertical direction, and comes down when the lens unit 21 is set on the lower support plate 80. As the upper support plate 79 approaches the lens unit 21, the positioning pins 82 of the upper support plate 79 enter the pair of positioning holes 67 on the top surface of the lens unit 21, and the shoulder portions 83 come into contact with the positioning surfaces 66. The lens unit 21 is now fixed to serve as reference position and angle in a three-dimensional space. At this point, the lens unit 21 is positioned to align the imaging optical axis 23 with a center point 85 of the test chart 77.

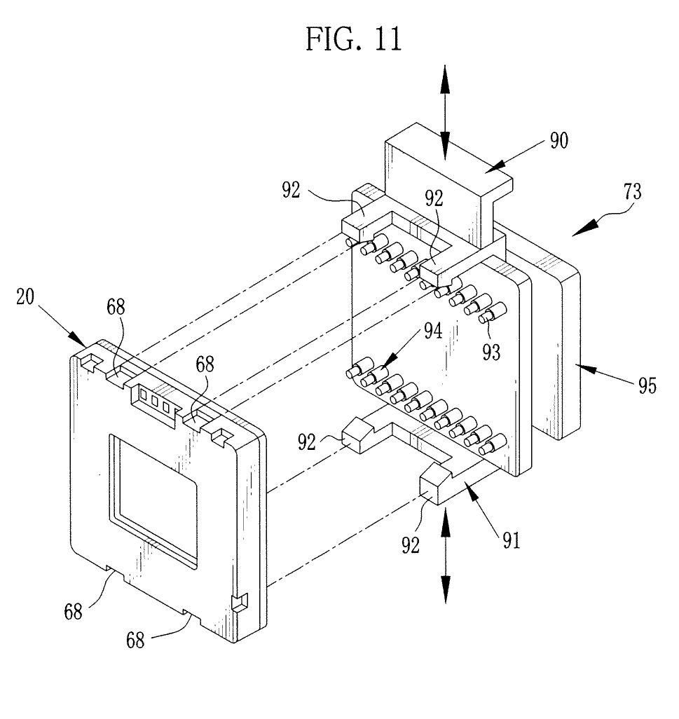

The upper support plate 79 also has a probe group 84 made up of a plurality of probes 84a. As the upper support plate 79 comes down, each probe 84a enters the opening 15 and touches the contact group 55 of the flexible board 24 for the inspection. As shown in FIG. 11, the sensor holding device 73 includes an upper lifting plate 90, a lower lifting plate 91, a shifting mechanism 96, a probe unit 94 and a tilting mechanism 95. Each of the upper and lower lifting plates 90, 91 has two elastic engaging claws 92. These engaging claws 92 approach the sensor unit 20 from behind, and engage with the four cutouts 68. The sensor unit 20 is now held by the sensor holding device 73. The shifting mechanism 96 moves forward and backward the sensor unit 20 along the imaging optical axis 23. Accordingly, the sensor unit 20 moves between a contact position in contact with the lens unit 21 and a distant position away from the lens unit 21. The probe unit 94 has a plurality of probes 93 to be connected to the rear terminal group 36 of the sensor unit 20 for the inspection. Each of the probes 93 has a tip slightly movable along the imaging optical axis 23, and this tip is kept pushed out by a spring.

The tilting mechanism 95 changes the angle of the sensor unit 20 to the lens unit 21. In particular, the tilting mechanism 95 turns the sensor unit 20 vertically and horizontally until the imaging plane of the image sensor 18 is orthogonal to the imaging optical axis 23.

The controller 76 drives the shifting mechanism 96 to set the sensor unit 20 in the contact position, and moves the taking lens 11 of the lens unit 21 to an in-focus position (focusing position depending on the distance to the test chart 77). Subsequently, the controller 76 moves the sensor unit 20 stepwise to the distant position by means of the shifting mechanism 96, and captures an image of the test chart 77 with the image sensor 18 whenever the sensor unit 20 moves a given distance. The controller 76 computes an optimum posture (the distance from the lens unit 21, and the angle in that position) to produce an image in a predetermined resolution. Lastly, the controller 76 drives the tilting mechanism 95 to adjust the relative positions of the sensor unit 20 and the lens unit 21 by setting the sensor unit 20 in the computed posture.

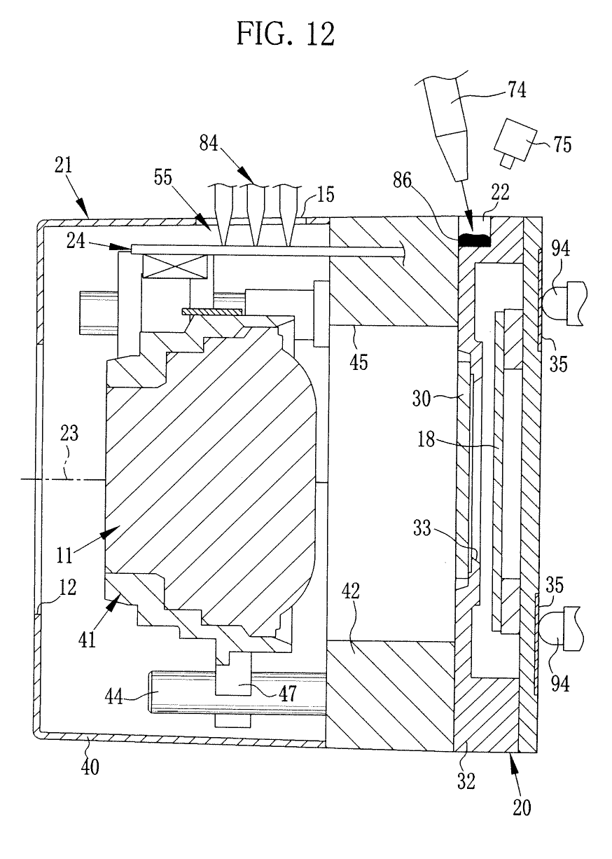

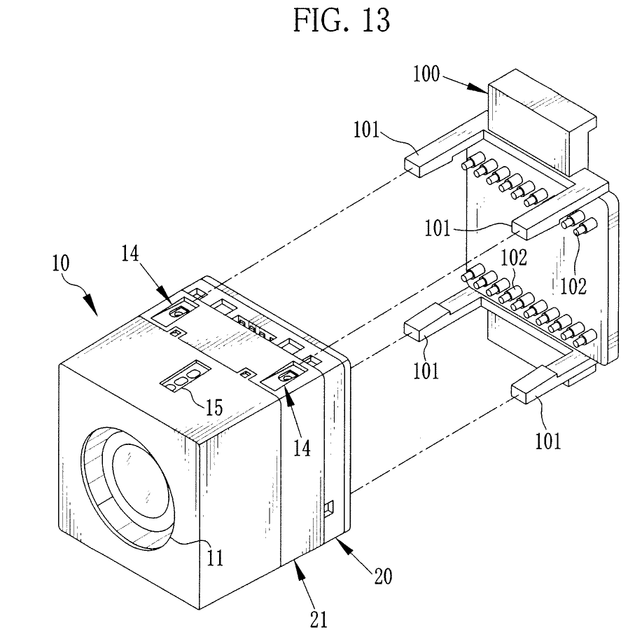

Thereafter, the fixing process is conducted. In the fixing process, as shown in FIG. 12, the controller 76 maintains the sensor unit 20 in position, and drives the resin injector 74 to apply an UV curable adhesive resin 86 into the adhesive receivers 22 of the sensor unit 20. Then, the UV ray irradiator 75 is driven to irradiate the UV ray that cures the UV curable adhesive resin 86. The sensor unit 20 and the lens unit 21 are now joined physically.

Finally, a conductive adhesive is applied between each terminal of the terminal group 25 on the flexible board 24 and each contact point of the contact group 27 on the sensor unit 20. The sensor unit 20 and the lens unit 21 are thereby electrically interconnected, and the camera module 10 is completed. This camera module 10 is sent to the quality inspection line.

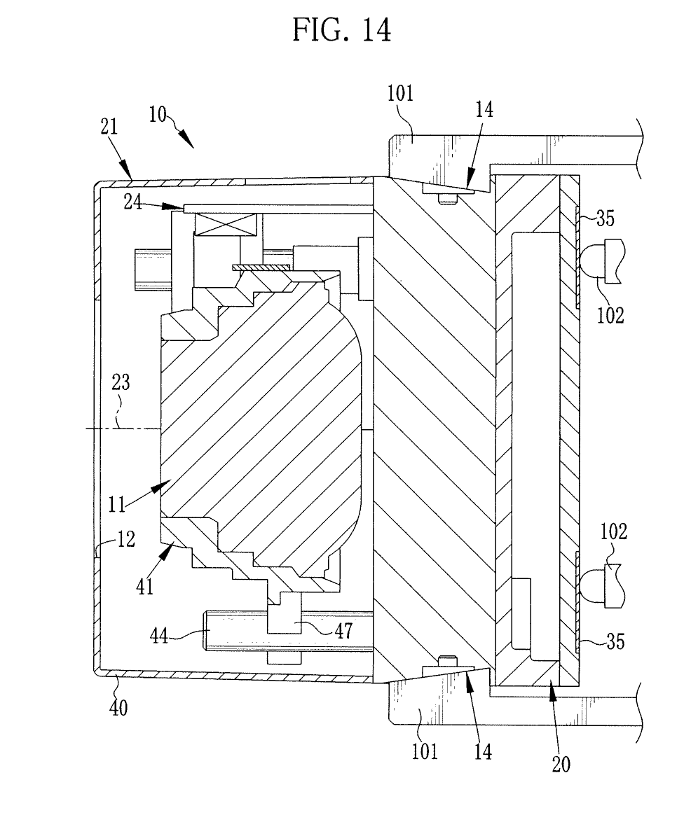

As shown in FIG. 13 and FIG. 14, in the quality inspection process, the camera module 10 is held in a certain position by the module holding device 100. The module holding device 100 includes four locking claw 101 to catch the held members 14 and a plurality of probes 102 to touch the rear terminal group 36 for the inspection. These probes 102 are movable along the imaging optical axis 23, and kept pushed out by springs. Similar to the sensor holding device 73, the module holding device 100 has a chart unit, a condenser lens and a controller for these components.

When the camera module 10 is set to the module holding device 100, the locking claws 101 are pressed against the rear of the camera module 10, and deform elastically to engage with the held members 14. At this point, the probes 102 touch the terminals 35 of the rear surface. The controller of the module holding device 100 moves the taking lens 11 to a certain position, and captures an image of the test chart with the image sensor 18. Based on the image data from the image sensor 18, the resolution of the captured image is inspected.

After the quality inspection process, the opening 15 is covered with the plate 16, and the camera module 10 is ready for shipping.

Instead of adjusting the position of the sensor unit 20 relative to the lens unit 21, the position of the lens unit 21 can be adjusted. In this case, the positioning members 13 and the held members 14 need to be provided on the sensor unit 20. Additionally, the probe group 84 should be inclined as the lens unit 21 is angled.

While the positioning members 13 and the held members 14 are placed in pairs on the top and bottom surfaces of the lens unit 21, they may be placed on the right and left surfaces.

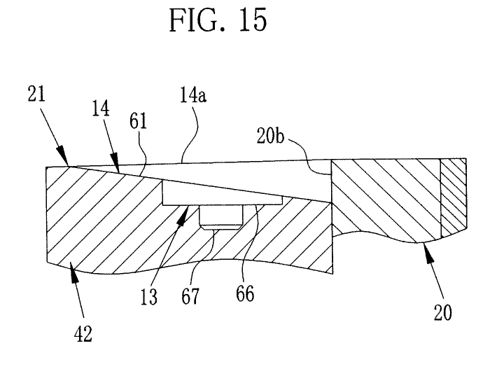

Although the held member 14 having a triangular cross section is formed on the lens unit 21 in the above embodiment, only the inclined bottom face 61 may be formed on the lens unit 21, as shown in FIG. 15, and a part of a front surface 20b of the sensor unit 20 may be used as the engaged face.

While the positioning member 13 of the above embodiment has the positioning surface 66 and the positioning hole 67, the positioning surface 66 is not essential. For example, the positioning hole 67 may be deepened to use its bottom as the positioning surface.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A camera module made by joining a lens unit holding a taking lens and a sensor unit holding an image sensor for capturing an image through said taking lens, said camera module comprising:
a pair of held members provided on top and bottom surfaces or both lateral surfaces of one of said lens unit and said sensor unit, each said held member being held by a holding jig in inspecting said camera module; and
a positioning member provided in each said held member and used for adjusting relative positions and angles of said lens unit and said sensor unit.

2. The camera module of claim 1, wherein said lens unit comprises a quadrilateral box.

3. The camera module of claim 2, wherein said held member comprises a depression of triangular cross section, and includes a bottom face inclined toward said image sensor.

4. The camera module of claim 3, wherein said positioning member comprises a positioning hole extending orthogonal to an optical axis of said taking lens and receiving a pin jig that holds said lens unit in joining said lens unit and said sensor unit.

5. The camera module of claim 3, wherein said positioning member comprises:
a positioning surface formed within said bottom face and extending parallel to an optical axis of said taking lens; and
a positioning hole formed on said positioning surface and extending orthogonal to said optical axis, said positioning hole receiving a pin jig that has a shoulder portion to make contact with said positioning surface and holds said lens unit in joining said lens unit and said sensor unit.
